(19) United States
(12) Patent Application Publication
(10) Pub. No.: US 2012/0075669 A1
(43) Pub. Date: Mar. 29, 2012

(54) IMAGE FORMING SYSTEM

(76) Inventor: Mitsuru TAKIGUCHI, Tokyo (JP)

(21) Appl. No.: 13/238,441

(22) Filed: Sep. 21, 2011

(30) Foreign Application Priority Data
Sep. 29, 2010 (JP) 2010-218259

(51) Int. Cl. G06K 15/02

(52) U.S. Cl. 358/1.15

(57) ABSTRACT

An image forming system includes an image forming apparatus and an upper device connected to the image forming apparatus through a communication path. The upper device includes a service attribution information input unit for inputting service attribution information containing service identification information; a service style table unit for containing a plurality of service styles each formed of a service setting value; and a service style deployment unit for selecting the service style according to the service identification information. The image forming apparatus includes a service attribution information storage unit for storing the service attribution information; and a service setting value storage unit for storing the service setting value. The service style deployment unit selects the service style when the service attribution information is input. Then, the upper device transmits the service setting value and the service attribution information to the image forming apparatus.

### BACKGROUND OF THE INVENTION AND RELATED ART STATEMENT

The present invention relates to an image forming system. More specifically, the present invention relates to an image forming system including an image forming apparatus and an upper device.

In a conventional image forming system, an upper device is configured to set an image forming apparatus through a network.

Patent Reference has disclosed such a conventional image forming system, in which it is possible to input administrator identification information through a simplified method when an administrator sets or updates an image forming apparatus or an option of the image forming apparatus.
Patent Reference Japanese Patent Publication No. 2006-72500

In the conventional image forming system disclosed in Patent Reference, when the number of setting items increases, for example, when a function is added, it is difficult to set the setting items easily.

In view of the problems described above, an object of the present invention is to provide an image forming system capable of solving the problems of the conventional image forming system.

Further objects and advantages of the invention will be apparent from the following description of the invention.

### SUMMARY OF THE INVENTION

In order to attain the objects described above, according to an aspect of the present invention, an image forming system includes an image forming apparatus and an upper device connected to the image forming apparatus through a communication path to be capable of communicating with each other.

In the aspect of the present invention, the upper device includes a service attribution information input unit for inputting service attribution information containing service identification information; a service style table unit for containing a plurality of service styles each formed of a service setting value; and a service style deployment unit for selecting one of the service styles according to the service identification information.

In the aspect of the present invention, the image forming apparatus includes a service attribution information storage unit for storing the service attribution information; and a service setting value storage unit for storing the service setting value.

In the aspect of the present invention, the upper device is configured such that the service style deployment unit selects the one of the service styles when the service attribution information containing the service identification information is input. Then, the upper device is configured to transmit the service setting value and the service attribution information in the one of the service styles to the image forming apparatus. The image forming apparatus receives and stores the service setting value and the service attribution information, thereby reflecting the service setting value and the service attribution information to an operation thereof.

As described above, according to the aspect of the present invention, the upper device includes the service style table unit and the service style deployment unit. Accordingly, it is possible to set the service setting value to the image forming apparatus all at once.

Further, when the service setting value and the service attribution information are set, the image forming apparatus performs a printing operation or an email transmission, or transmits an email to the upper device to display on a screen. Accordingly, immediately after the service style is set, it is possible for a user to confirm the service style. Further, even when the setting of the image forming apparatus is unexpectedly changed, it is possible to identify a setting item thus changed and an update date.

### BRIEF DESCRIPTION OF THE DRAWINGS

FIG. 1 is a block diagram showing a configuration of an image forming system according to a first embodiment of the present invention;

FIG. 2 is a schematic view showing a service attribution information setting screen of an upper device of the image forming system according to the first embodiment of the present invention;

FIG. 3 is a schematic view showing a service style table of the upper device of the image forming system according to the first embodiment of the present invention;

FIG. 4 is a flow chart showing an operation of the upper device of the image forming system according to the first embodiment of the present invention;

FIG. 5 is a block diagram showing a configuration of an image forming system including a first upper device according to a second embodiment of the present invention;

FIG. 6 is a block diagram showing a configuration of the image forming system including a second upper device according to the second embodiment of the present invention;

FIG. 7 is a schematic view showing a setting screen of a service configuration destination and a valid date of the image forming system according to the second embodiment of the present invention;

FIG. 8 is a schematic view showing a service configuration file of the image forming system according to the second embodiment of the present invention;

FIG. 9 is a schematic view showing a service configuration file setting screen of the image forming system according to the second embodiment of the present invention;

FIG. 10 is a flow chart showing an operation of the first upper device of the image forming system according to the second embodiment of the present invention; and

FIG. 11 is a flow chart showing an operation of the second upper device of the image forming system according to the second embodiment of the present invention.

### DETAILED DESCRIPTION OF PREFERRED EMBODIMENTS

Hereunder, embodiments of the present invention will be explained with reference to the accompanying drawings. It is noted that the drawings are presented for an explanation purpose only, and the present invention is not limited to the drawings.

### First Embodiment

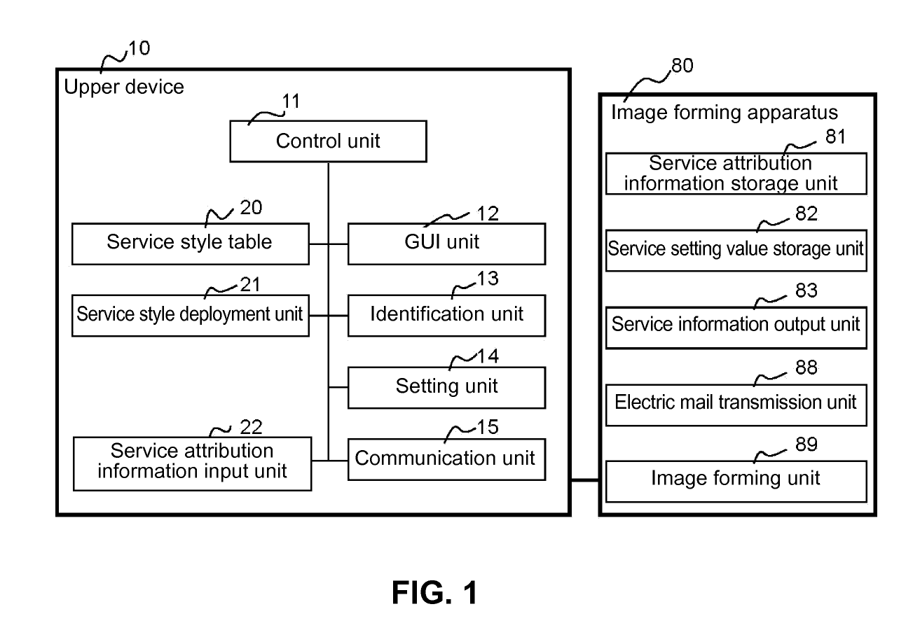

A first embodiment of the present invention will be explained. FIG. 1 is a block diagram showing a configuration of an image forming system according to the first embodiment of the present invention.

As shown in FIG. 1, the image forming system includes an image forming apparatus 80 and an upper device 10 connected to the image forming apparatus 80 through a communication path to be capable of communicating with each other.

In the embodiment, the upper device 10 includes a control unit 11; a GUI (Graphic User Interface) unit 12; an identification unit 13; a setting unit 14; a communication unit 15; a service style table 20; a service style deployment unit 21; and a service attribution information input unit 22.

In the embodiment, the control unit 11 is provided for controlling an entire operation of the upper device 10. The GUI unit 12 includes a screen portion for displaying an operation screen and an input portion for receiving an input of a user. The identification unit 13 is provided for identifying the user of the image forming system according to, for example, a user ID and a password input through the GUI (Graphic User Interface) unit 12. The setting unit 14 is provided for temporarily storing information to be set relative to the image forming apparatus 80. The communication unit 15 is provided for transmitting and receiving data relative to the image forming apparatus 80 through a communication line.

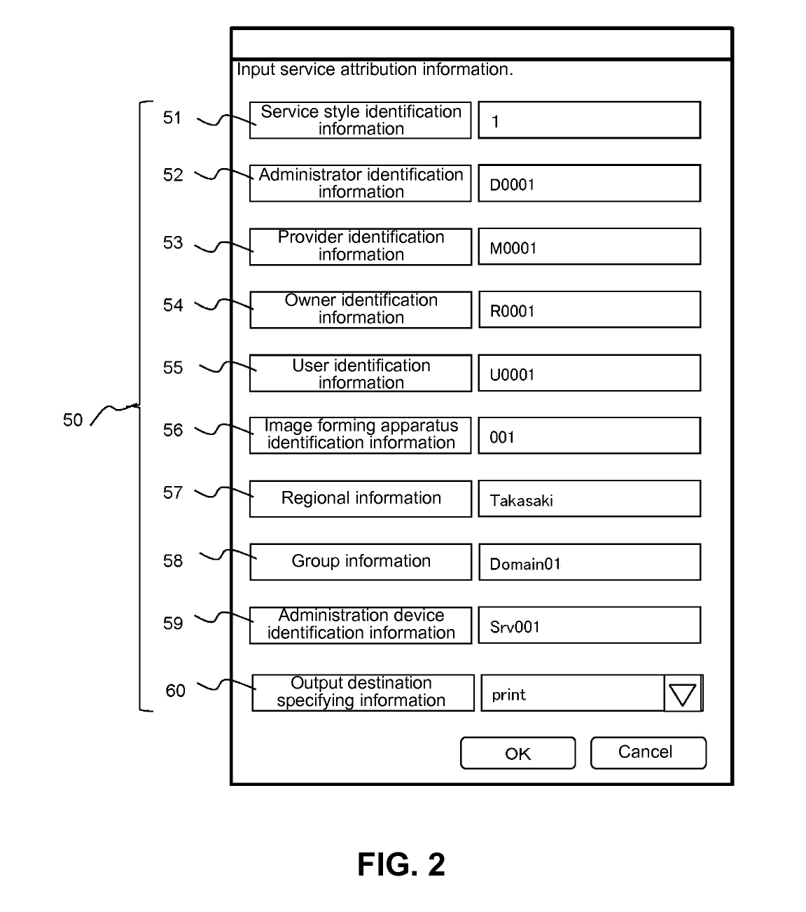

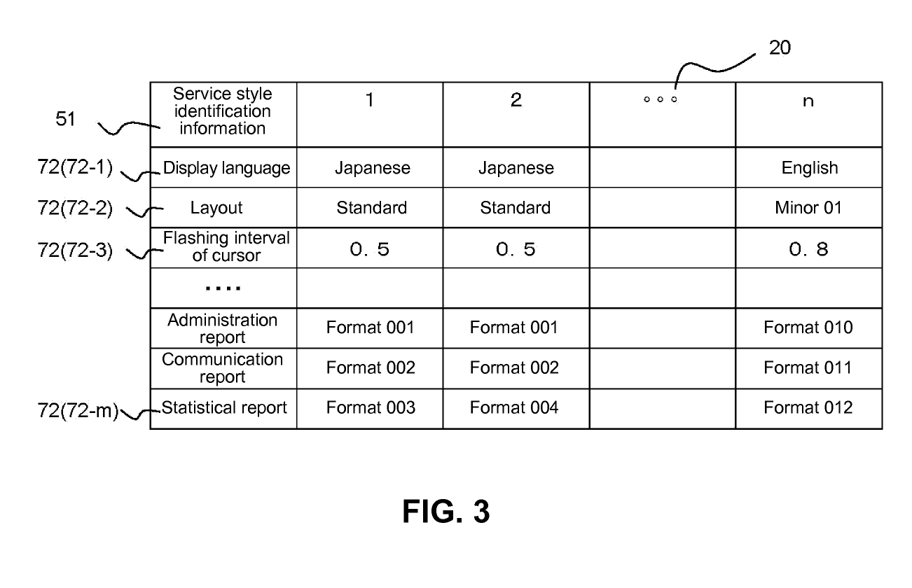

In the embodiment, the service style table 20 (described later, refer to FIG. 3) is provided for representing a relationship between service style identification information 51 and service setting values 72 (72-1 to 72-m). The service style deployment unit 21 is provided for determining the service setting values 72 (described later, refer to FIG. 3) from the service style identification information 51. The service attribution information input unit 22 is provided for inputting service attribution information 50 necessary for maintaining and administrating a service through a service attribution information setting screen (described later, refer to FIG. 2).

In the embodiment, the image forming apparatus 80 includes a service attribution information storage unit 81; a service setting value storage unit 82; a service information output unit 83; an electric mail transmission unit 88; and an image forming unit 89.

In the embodiment, the service attribution information storage unit 81 is provided for storing the service attribution information 50 (described later, refer to FIG. 2) input through the service attribution information input unit 22. The service setting value storage unit 82 is provided for storing the service setting values 72 (described later, refer to FIG. 3) determined with the service style deployment unit 21. The service information output unit 83 is provided for printing information related to the service attribution information storage unit 81 and the service setting value storage unit 82 with the image forming unit 89, or for transmitting the information to display on the GUI (Graphic User Interface) unit 12, or for transmitting the information with an electric mail with the electric mail transmission unit 88 to a destination specified in advance. The electric mail transmission unit 88 is provided for transmitting the electric mail to the destination specified in advance through a communication line (not shown). The image forming unit 89 is provided for forming an image on a recording medium.

FIG. 2 is a schematic view showing the service attribution information setting screen of the upper device 10 of the image forming system according to the first embodiment of the present invention. The service attribution information setting screen is provided for inputting the service attribution information 50.

As shown in FIG. 2, the service attribution information setting screen includes an input column of the service style identification information 51; an input column of administrator identification information 52; an input column of provider identification information 53; an input column of owner identification information 54; an input column of user identification information 55; an input column of image forming apparatus identification information 56; an input column of regional information 57; an input column of group information 58; an input column of administration device identification information 59; a selection menu of output destination specifying information 60; an OK button; and a cancel button.

In the embodiment, the service style identification information 51 is information for identifying a service style. The administrator identification information 52 is information for identifying an administrator that administrates a service. The provider identification information 53 is information for identifying a provider that provides a service. The owner identification information 54 is information for identifying an owner of the image forming apparatus 80. The user identification information 55 is information for identifying a user of the image forming apparatus 80. The image forming apparatus identification information 56 is information for identifying the image forming apparatus 80. The regional information 57 is information for identifying an installation location of the image forming apparatus 80. The group information 58 is information for identifying a group to which the image forming apparatus 80 belongs.

In the embodiment, the administration device identification information 59 is information for identifying an administration device that administers the image forming apparatus 80. The output destination specifying information 60 is information for determining whether the service attribution information 50 and the service setting values 72 (described later, refer to FIG. 3) are printed, displayed on a screen, or transmitted with an electric mail.

In the embodiment, when the user inputs all of the input columns of the service attribution information 50, and clicks the OK button, the service attribution information setting screen disappears, so that the service attribution information 50 is input. When the user clicks the cancel button, the service attribution information setting screen disappears, so that the input contents are cancelled.

FIG. 3 is a schematic view showing the service style table 20 of the upper device 10 of the image forming system according to the first embodiment of the present invention.

As shown in FIG. 3, the service style table 20 represents the relationship between the service attribution information 50 and the service setting values 72. More specifically, the service setting value 72-1 represents a display language; the service setting value 72-2 represents a layout; and the service setting value 72-3 represents a flashing interval of a cursor of a display portion. The service setting values 72-4 to 72-m represent various statistical reports. A combination of the service setting values 72-1 to 72-m is selected through the service style identification information 51.

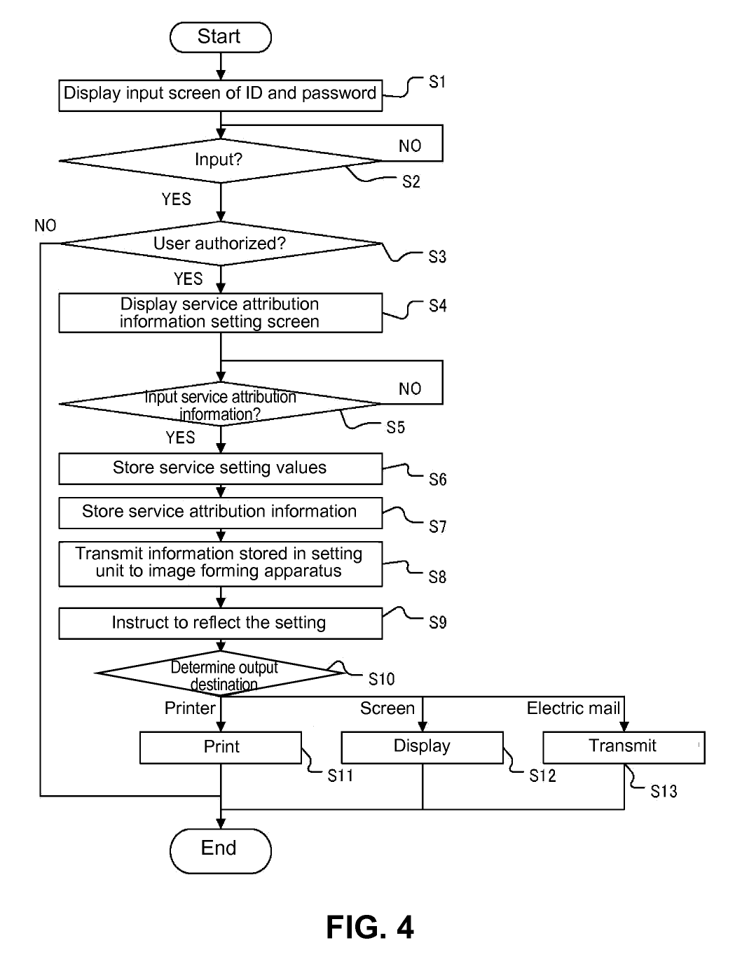

An operation of the upper device 10 of the image forming system will be explained next. FIG. 4 is a flow chart showing the operation of the upper device 10 of the image forming system according to the first embodiment of the present invention.

In step S1, when the upper device 10 starts a process, the identification unit 13 of the upper device 10 displays the input screen of the ID and the password. In step S2, it is determined whether the ID and the password are input, so that the upper device 10 waits until the ID and the password are input. In step S3, it is determined whether the user is authorized. When it is determined that the user is authorized, the process proceeds to step S4. When it is determined that the user is not authorized, the process is complete.

In step S4, the upper device 10 displays the service attribution information setting screen shown in FIG. 2 on the GUI (Graphic User Interface) unit 12. In step S5, it is determined whether the service attribution information 50 is input, so that the upper device 10 waits until the service attribution information 50 is input.

In step S6, the service style deployment unit 21 of the upper device 10 obtains the service setting values 72 from the service style table 20 according to the service style identification information 51, and stores the service setting values 72 in the setting unit 14. In step S7, the upper device 10 stores the service attribution information 50 thus input in the setting unit 14. In step S8, the communication unit 15 of the upper device 10 transmits the service setting values 72 and the service attribution information 50 stored in the setting unit 14 to the image forming apparatus 80. When the image forming apparatus 80 receives the service setting values 72 and the service attribution information 50, the image forming apparatus 80 stores the service setting values 72 in the service setting value storage unit 82 and the service attribution information 50 in the service attribution information storage unit 81. In step S9, the upper device 10 instructs the image forming apparatus 80 to reflect the setting, so that the image forming apparatus 80 reflects the service setting values 72 stored in the service setting value storage unit 82.

In step S10, the service information output unit 83 of the image forming apparatus 80 determines the output destination specifying information 60 of the service attribution information 50 stores in the service attribution information storage unit 81 and the service setting values 72 stored in the service setting value storage unit 82 according to the output destination specifying information 60. In step S11, when the service information output unit 83 determines that the printer is specified in the output destination specifying information 60, the image forming unit 89 prints on the recording medium, thereby completing the process. In step S12, when the service information output unit 83 determines that the screen is specified in the output destination specifying information 60, the service attribution information 50 and the service setting values 72 are transmitted to the upper device 10 to display on the GUI (Graphic User Interface) unit 12, thereby completing the process. In step S13, when the service information output unit 83 determines that the electric mail is specified in the output destination specifying information 60, the electric mail transmission unit 88 transmits the electric mail to a destination specified in advance, thereby completing the process.

In the embodiment, when the user confirms the service attribution information 50 and the service setting values 72, it is possible to confirm the setting reflected on the image forming apparatus 80.

As described above, in the embodiment, the upper device 10 includes the service style table 20 and the service style deployment unit 21. Accordingly, it is possible to collectively set the service attribution information 50 to the image forming apparatus 80 all at once.

Further, in the embodiment, when the service attribution information 50 and the service setting values 72 are set, the service information output unit 83 of the image forming apparatus 80 performs one of the printing operation, the screen display, and the electric mail transmission. Accordingly, it is possible for the user to confirm the setting immediately after the service style is set. Further, even when the setting of the image forming apparatus 80 is inadvertently changed, it is possible to identify the setting item thus changed and the change time.

Further, in the embodiment, the upper device 10 includes the identification unit 13. Accordingly, it is possible to limit the user who can use the upper device 10 to set and change the service style of the image forming apparatus 80 to an authorized person.

### Second Embodiment

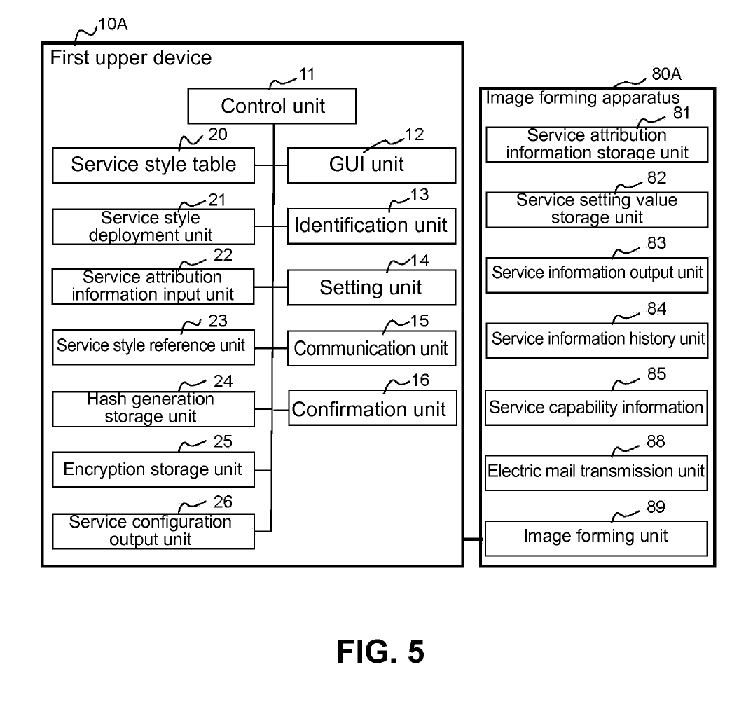

A second embodiment of the present invention will be explained next. FIG. 5 is a block diagram showing a configuration of an image forming system including a first upper device 10A according to the second embodiment of the present invention. Components shown in FIG. 5 and similar to those shown in FIG. 1 in the first embodiment are designated with the same reference numerals.

As shown in FIG. 5, the image forming system in the second embodiment includes the first upper device 10A different from the upper device 10 in the first embodiment and an image forming apparatus 80A different from the image forming apparatus 80 in the first embodiment. The first upper device 10A is connected to the image forming apparatus 80A through a communication path to be capable of communicating with each other.

In the second embodiment, in addition to the configuration of the upper device 10 in the first embodiment, the first upper device 10A includes a confirmation unit 16; a service style reference unit 23; a hash generation storage unit 24; an encryption storage unit 25; and a service configuration output unit 26. The confirmation unit 16, the service style reference unit 23, the hash generation storage unit 24, the encryption storage unit 25, and the service configuration output unit 26 are connected to the control unit 11 through a bus.

In the second embodiment, the confirmation unit 16 is provided for displaying a confirmation screen on the GUI (Graphic User Interface) unit 12, and for receiving an input of OK/NG through an input portion. The service style reference unit 23 is provided for confirming whether each of the settings of the service style table 20 in the service style identification information 51 is within an acceptable range of each of settings in service capability information 85 and the image forming apparatus 80A.

In the second embodiment, the hash generation storage unit 24 is provided for generating and storing hash information 64 (described later, refer to FIG. 8) from the service attribution information 50 and the service setting values 72 stored in the setting unit 14. More specifically, the hash generation storage unit 24 is provided for obtaining the hash information 64 through, for example, dividing binary data of the service setting values 72 per 128 bits, and calculating each value with a check sum method to obtain the hash information 64. It is noted that the hash generation storage unit 24 may obtain the hash information 64 through other hash functions.

In the second embodiment, the encryption storage unit 25 is provided for encrypting the service attribution information 50 and the service setting values 72 stored in the setting unit 14, and for generating and storing encryption setting information 63 (described later, refer to FIG. 8). It is noted that the encryption storage unit 25 encrypts the service attribution information 50 and the service setting values 72 with an encryption method such as, for example, AES (Advanced Encryption Standard), DES (Data Encryption Standard), RC4 (Rivest Cipher 4), RAS encryption, oval curve encryption, and the like.

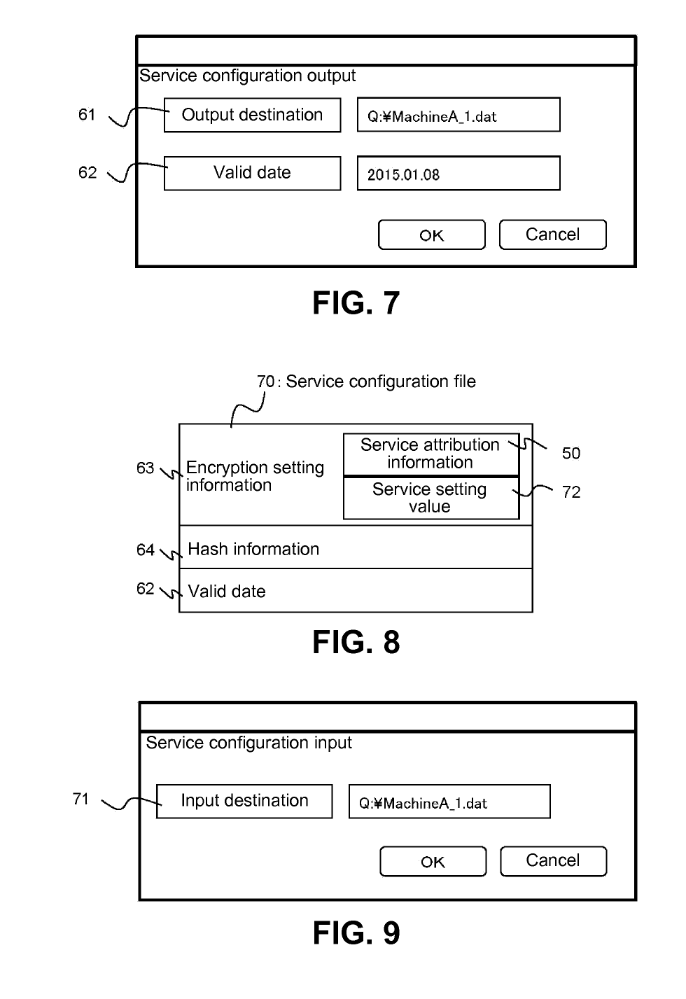

In the second embodiment, the service configuration output unit 26 is provided for outputting a service configuration file 70 (described later, refer to FIG. 8) according to an output destination 61 and a valid date 62 (described later, refer to FIG. 7).

In the embodiment, in addition to the configuration of the image forming apparatus 80 in the first embodiment, the image forming apparatus 80A includes a service information history unit 84 and the service capability information 85.

In the second embodiment, the service information history unit 84 is provided for storing a history of information of the service attribution information storage unit 81 and the service setting value storage unit 82. The service capability information 85 is provided for storing the acceptable range of the setting items related to the service setting values 72 of the image forming apparatus 80A. The service capability information 85 is stored in the image forming apparatus 80A in advance.

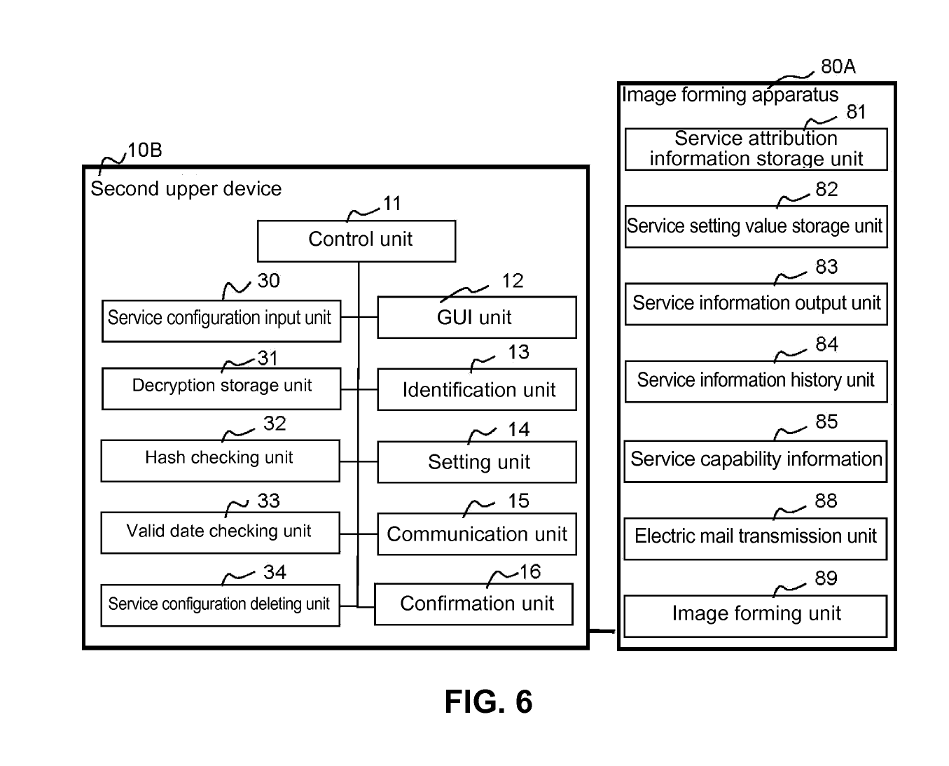

FIG. 6 is a block diagram showing a configuration of the image forming system including a second upper device 10B according to the second embodiment of the present invention.

As shown in FIG. 6, the image forming system in the second embodiment includes the second upper device 10B different from the upper device 10 in the first embodiment and the image forming apparatus 80A different from the image forming apparatus 80 in the first embodiment. The second upper device 10B is connected to the image forming apparatus 80A through a communication path to be capable of communicating with each other.

In the second embodiment, similar to the upper device 10 in the first embodiment, the second upper device 10B includes the control unit 11, the GUI (Graphic User Interface) unit 12, the identification unit 13, the setting unit 14, and the communication unit 15. Further, the second upper device 10B includes the confirmation unit 16, a service configuration input unit 30; a decryption storage unit 31; a hash checking unit 32; a valid date checking unit 33; and a service configuration deleting unit 34. The service configuration input unit 30, the decryption storage unit 31, the hash checking unit 32, the valid date checking unit 33, and the service configuration deleting unit 34 are connected to the control unit 11 through a bus.

In the second embodiment, the confirmation unit 16 has a function similar to that of the confirmation unit 16 of the first upper device 10A. The service configuration input unit 30 is provided for reading the service configuration file 70 (described later, refer to FIG. 8) output from the service configuration output unit 26 of the first upper device 10A. More specifically, the user specifies an input destination 71 through a service configuration file setting screen (described later, refer to FIG. 9), so that the service configuration input unit 30 retrieves the service configuration file 70 (described later, refer to FIG. 8).

In the second embodiment, the decryption storage unit 31 has a function of decrypting original information from the information encrypted with the encryption storage unit 25. Further, the decryption storage unit 31 is provided for retrieving and decrypting the encryption setting information 63 from the service configuration file 70 retrieved with the service configuration input unit 30, so that the decryption storage unit 31 generates and stores decryption setting information.

In the second embodiment, the hash checking unit 32 is provided for identifying the hash information 64 as a second hash value after the service configuration input unit 30 retrieves the service configuration file 70 (described later, refer to FIG. 8), and for calculating a first has value through a hash function identical to the hash generation storage unit 24 from the decryption setting information stored in the decryption storage unit 31. Further, the hash checking unit 32 is provided for determining whether the first has value matches to the hash information 64.

In the second embodiment, the valid date checking unit 33 is provided for identifying the valid date 62 after the service configuration input unit 30 retrieves the service configuration file 70 (described later, refer to FIG. 8), and for comparing the valid date 62 with a current date and time. When the valid date checking unit 33 determines that the current date and time exceeds the valid date 62, the valid date checking unit 33 determines invalid. When the valid date checking unit 33 determines that the current date and time exceeds the valid date 62, the valid date checking unit 33 determines valid.

FIG. 7 is a schematic view showing the setting screen of the service configuration destination 61 and the valid date 62 of the image forming system according to the second embodiment of the present invention.

In the second embodiment, the output destination 61 is, for example, file path information. As shown in FIG. 7, the output destination 61 is shown as the file path information having a file name “MachineA_{—}1.dat” under a Q drive. The valid date 62 is information of year, date, and time. As shown in FIG. 7, the valid date 62 is shown as Jan. 8, 2015.

In the second embodiment, when the user inputs the output destination 61 and the valid date 62 and clicks an OK button, the setting screen disappears, so that the output destination 61 and the valid date 62 are input. When the user clicks a cancel button, the setting screen disappears, so that the input contents are cancelled. The setting screen of the output destination 61 and the valid date 62 shown in FIG. 7 is a valid date setting portion for setting the valid date 62 in the service setting values 72 and/or the service attribution information 50.

FIG. 8 is a schematic view showing the service configuration file 70 of the image forming system according to the second embodiment of the present invention.

As shown in FIG. 8, the service configuration file 70 includes the encryption setting information 63, the hash information 64, and the valid date 62. Further, the encryption setting information 63 includes the service attribution information 50 and the service configuration file 70 encrypted with the encryption storage unit 25.

FIG. 9 is a schematic view showing the service configuration file setting screen of the image forming system according to the second embodiment of the present invention.

In the second embodiment, the input destination 71 is information indicating the service configuration file 70 such as, for example, the file path information. As shown in FIG. 9, the input destination 71 is shown as the file path information having the file name “MachineA_{—}1.dat” under the Q drive. When the user clicks an OK button, the second upper device 10B retrieves the service configuration file 70 according to the information of the input destination 71. When the user clicks a cancel button, the input of the input destination 71 is cancelled.

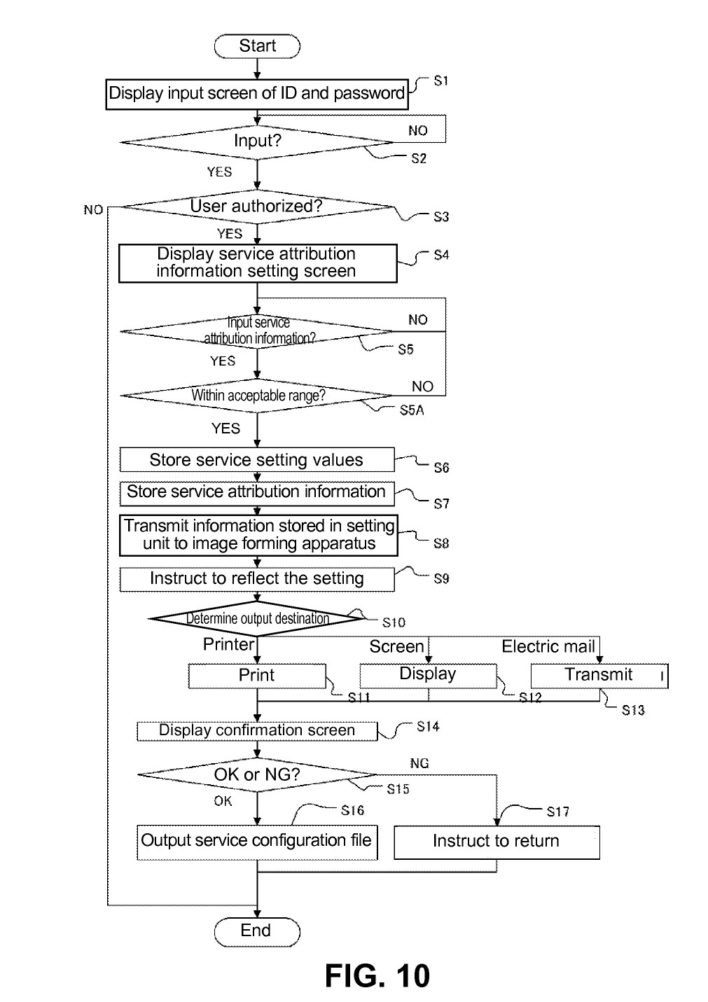

An operation of the first upper device 10A will be explained next. FIG. 10 is a flow chart showing the operation of the first upper device 10A of the image forming system according to the second embodiment of the present invention. Steps of the operation of the first upper device 10A similar to those shown in FIG. 4 are designated with the same numeral references.

After the process starts, the process from step S1 to step S5 is similar to that from step S1 to step S5 in the first embodiment. In step S5A, the service style reference unit 23 of the first upper device 10A determines whether the settings of the service style table 20 in the service style identification information 51 are within the acceptable range of the settings in the service capability information 85 of the image forming apparatus 80A. When the service style reference unit 23 determines that the settings of the service style table 20 are within the acceptable range of the settings in the service capability information 85, the process proceeds to step S6. Afterward, the process from step S6 to step S13 is similar to that from step S6 to step S13 in the first embodiment.

In step S14, the confirmation unit 16 of the first upper device 10A displays the confirmation screen of the output contents in the process from step S11 to step S13, so that the user is prompted to input OK or NG. In step S15, it is confirmed whether the user inputs OK or NG. In step S16, when the user inputs OK, the service configuration output unit 26 outputs the service configuration file 70 shown in FIG. 8, thereby completing the process shown in FIG. 10. In step S17, when the user inputs NG, the first upper device 10A instructs the image forming apparatus 80A to return, thereby completing the process shown in FIG. 10.

In the embodiment, when the first upper device 10A instructs the image forming apparatus 80A to return, the image forming apparatus 80A sets the state stored in the service information history unit 84 before the change in the service setting value storage unit 82 and the service attribution information storage unit 81. Accordingly, the setting value of the service setting value storage unit 82 is reflected in the image forming apparatus 80A.

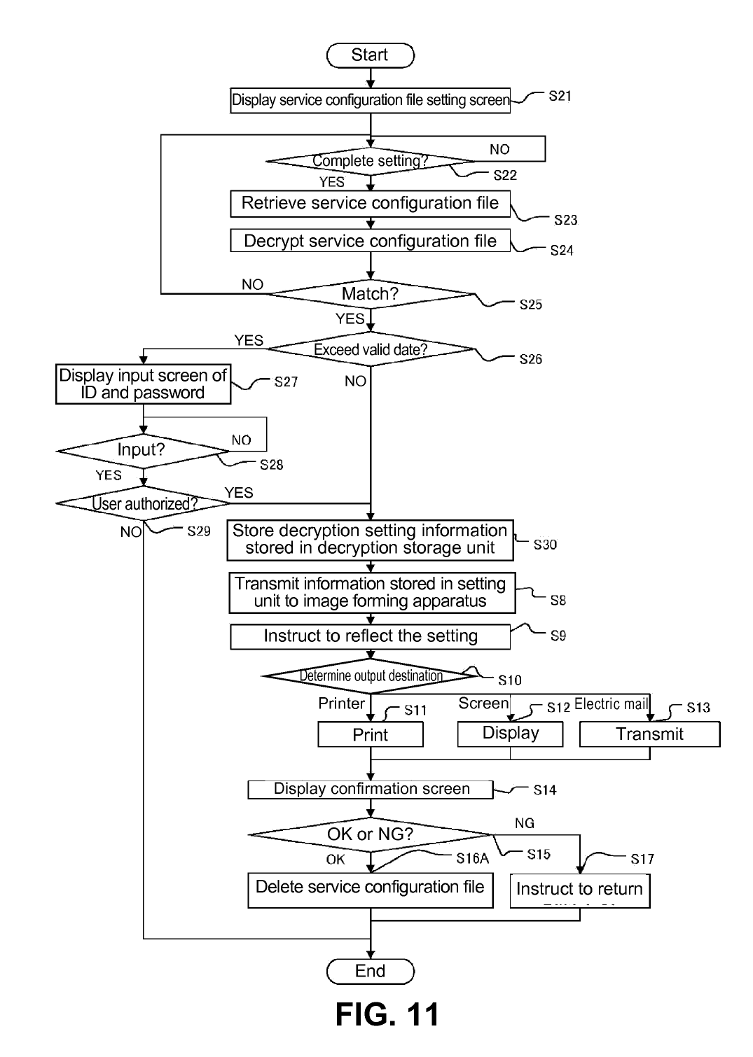

An operation of the second upper device 10B will be explained next. FIG. 11 is a flow chart showing the operation of the second upper device 10B of the image forming system according to the second embodiment of the present invention. Steps of the operation of the second upper device 10B similar to those shown in FIG. 4 are designated with the same numeral references.

In step S21, when the process starts, the second upper device 10B displays the service configuration file setting screen shown in FIG. 9. In step S22, the upper device 10 determines whether the setting is complete. In step S23, the service configuration input unit 30 retrieves the service configuration file 70 specified. In step S24, the decryption storage unit 31 decrypts the encryption setting information 63 of the service configuration file 70, and stores the decryption setting information.

In step S25, the hash checking unit 32 calculates the hash value from the decryption setting information stored with the decryption storage unit 31, and determines whether the hash value matches to the hash information 64. When the hash checking unit 32 determines that the hash value does not match to the hash information 64, the process returns to step S22. When the hash checking unit 32 determines that the hash value matches to the hash information 64, the process proceeds to step S26.

In step S26, the valid date checking unit 33 compares the valid date 62 of the service configuration file 70 with the current date. When the valid date checking unit 33 determines that the current date exceeds the valid date 62, the valid date checking unit 33 determines invalid, and the process proceeds to step S27. When the valid date checking unit 33 determines that the current date does not exceed the valid date 62, the valid date checking unit 33 determines valid, and the process proceeds to step S30.

In step S27, the identification unit 13 displays the input screen of the ID and the password. In step S28, it is determined whether the ID and the password are input, so that the second upper device 10B waits until the ID and the password are input. In step S29, it is determined whether the user is authorized. When it is determined that the user is authorized, the process proceeds to step S30. When it is determined that the user is not authorized, the process shown in FIG. 11 is complete.

In step S30, the second upper device 10B stores the decryption setting information stored in the decryption storage unit 31 in the setting unit 14. The process from step S8 to step S13 is similar to that from step S8 to step S13 in the first embodiment.

In step S14, the confirmation unit 16 of the first upper device 10A displays the confirmation screen of the output contents in the process from step S11 to step S13, so that the user is prompted to input OK or NG. In step S16A, when the user inputs OK, the service configuration deleting unit 34 deletes the service configuration file 70, thereby completing the process shown in FIG. 11. In step S17, when the user inputs NG, the second upper device 10B instructs the image forming apparatus 80A to return, thereby completing the process shown in FIG. 11.

In the embodiment, when the second upper device 10B instructs the image forming apparatus 80A to return, the image forming apparatus 80A sets the state stored in the service information history unit 84 before the change in the service setting value storage unit 82 and the service attribution information storage unit 81. Accordingly, the setting value of the service setting value storage unit 82 is reflected in the image forming apparatus 80A.

As explained above, in the second embodiment, in addition to the effects in the first embodiment, it is possible to provide the following effects. First, the image forming system includes the second upper device 10B in addition to the first upper device 10A. The second upper device 10B is not provided with the service style table 20. Accordingly, every time the service is added and the service style table 20 is updated, the service style table 20 is not affected by the update. As a result, it is possible to reduce a memory resource of the second upper device 10B as compared with the first upper device 10A.

Further, in the second embodiment, it is configured to store the service setting values 72 and the service attribution information 50 in the service configuration file 70. Accordingly, when the image forming apparatus 80A is exchanged or the image forming apparatus 80 is reset after an initialization thereof, it is possible to skip the step of inputting the service attribution information 50.

Further, in the second embodiment, the image forming apparatus 80A includes the service capability information 85, and the service style reference unit 23 of the first upper device 10A determines whether it is within the acceptable range of the service setting values 72. Accordingly, it is possible to prevent input of a wrong value of the service style identification information 51.

Further, in the second embodiment, the first upper device 10A includes the hash generation storage unit 24, and the second upper device 10B includes the hash checking unit 32. Accordingly, it is possible to prevent mistakenly specifying a different type of file other than the service configuration file 70.

Further, in the second embodiment, the first upper device 10A includes the encryption storage unit 25, and the second upper device 10B includes the decryption storage unit 31. Accordingly, it is possible to prevent the contents of the service configuration file 70 from leaking.

Further, in the second embodiment, the service configuration output unit 26 of the first upper device 10A is configured to set the valid date 62 in the service configuration file 70, and the second upper device 10B includes the valid date checking unit 33 for comparing the valid date 62 with the current date. Accordingly, it is possible to set the valid date 62 in consideration of the product life cycle. Further, even when the product life cycle is expired, it is possible for the authorized user to set.

Further, in the second embodiment, the second upper device 10B includes the service configuration deleting unit 34, so that the service configuration file 70 is automatically deleted after the setting is complete. Accordingly, it is possible to prevent the service configuration file 70 from being accumulated unnecessarily in the storage unit of the image forming system.

As explained above, the present invention is applicable to the embodiments described above, and may be applicable to other configurations and modifications. For example, the upper device 10 in the first embodiment or the first upper device 10A and the second upper device 10B in the second embodiment can be realized with a computer or application software.

Further, in the second embodiment, the first upper device 10A includes the service style reference unit 23. Alternatively, the second upper device 10B may include the service style reference unit 23, so that the wrong setting of the service configuration file 70 is detected. Accordingly, it is possible to prevent the wrong setting of the service configuration file 70.

Further, in the second embodiment, the second upper device 10B includes the service configuration deleting unit 34, so that the service configuration file 70 is automatically deleted after the setting is complete. Alternatively, the service configuration file 70 may be moved to other folder instead of being deleted.

The disclosure of Japanese Patent Application No. 2010-218259, filed on Sep. 29, 2010, is incorporated in the application by reference.

While the invention has been explained with reference to the specific embodiments of the invention, the explanation is illustrative and the invention is limited only by the appended claims.

What is claimed is:

1. An image forming system, comprising:
an image forming apparatus; and
an upper device connected to the image forming apparatus through a communication path to be capable of communicating with each other,
wherein said upper device includes:
a service attribution information input unit for inputting service attribution information containing service identification information;
a service style table unit for containing a plurality of service styles each formed of a service setting value; and
a service style deployment unit for selecting one of the service styles according to the service identification information,
said image forming apparatus includes:
a service attribution information storage unit for storing the service attribution information; and
a service setting value storage unit for storing the service setting value,
said upper device is arranged so that the service style deployment unit selects the one of the service styles when the service attribution information containing the service identification information is input,
said upper device is arranged to transmit the service setting value and the service attribution information in the one of the service styles to the image forming apparatus, and
said image forming apparatus receives and stores the service setting value and the service attribution information, thereby reflecting the service setting value and the service attribution information to an operation thereof.

2. The image forming system according to claim 1, wherein said image forming apparatus further includes an image forming unit for printing the service setting value and the service attribution information.

3. The image forming system according to claim 1, wherein said image forming apparatus further includes an electric mail transmission unit for transmitting an electric mail containing the service setting value and the service attribution information.

4. The image forming system according to claim 1, wherein said upper device further includes a screen portion for displaying the service setting value and the service attribution information transmitted from the image forming apparatus.

5. The image forming system according to claim 1, wherein said image forming apparatus further includes a service information history unit for storing a history of the service setting value and/or the service attribution information, and said upper device further includes a confirmation unit for displaying a confirmation screen and receiving an input of OK or NG, said confirmation unit being arranged to display the confirmation screen after the upper device transmits the service setting value and the service attribution information in the one of the service styles to the image forming apparatus, said upper device being arranged to instruct the image forming apparatus to return to the service setting value and the service attribution information in a previous history when the confirmation unit receives the input of NG.

6. The image forming system according to claim 5, wherein said image forming apparatus further includes service configuration output unit for outputting the service setting value and the service attribution information to a service configuration file, said confirmation unit being arranged to display the confirmation screen after the upper device transmits the service setting value and the service attribution information in the one of the service styles to the image forming apparatus, said service configuration output unit being arranged to output the service setting value and the service attribution information to the service configuration file when the confirmation unit receives the input of OK.

7. The image forming system according to claim 1, wherein said image forming apparatus further includes service capability information representing an acceptable range of the service setting value in the one of the service style, and said upper device further includes a service style reference unit for determining whether the service setting value is within the acceptable range, said upper device being arranged to retrieve the acceptable range from the service capability information when the service attribution information is input so that the service attribution information is input one more time when the service style reference unit determines that the service setting value is not within the acceptable range.

8. The image forming system according to claim 1, wherein said upper device further includes an identification unit for inputting identification information of a user to determine whether the identification information is valid so that the service attribution information input unit inputs the service attribution information when the identification unit determines that the identification information is valid.

9. An image forming system, comprising:
an image forming apparatus;
a first upper device connected to the image forming apparatus through a communication path to be capable of communicating with each other; and
a second upper device connected to the image forming apparatus through the communication path to be capable of communicating with each other,
wherein said first upper device includes:
a service attribution information input unit for inputting service attribution information containing service identification information;
a service style table unit for containing a plurality of service styles each formed of a service setting value;
a service style deployment unit for selecting one of the service styles according to the service identification information; and
a service configuration output unit for outputting the service setting value and the service attribution information to a service configuration file,
said second upper device includes:
a service configuration input unit for inputting the service configuration file to identify the service setting value and the service attribution information,
said image forming apparatus includes:
a service attribution information storage unit for storing the service attribution information; and
a service setting value storage unit for storing the service setting value,
said first upper device is arranged such that the service style deployment unit selects one of the service styles when the service attribution information containing the service identification information is input,
said first upper device is arranged to transmit the service setting value and the service attribution information in the one of the service styles to the image forming apparatus, and to output the service setting value and the service attribution information to the service configuration file,
said second upper device is arranged to identify and transmit the service setting value and the service attribution information to the image forming apparatus when the service setting value and the service attribution information are output to the service configuration file, and
said image forming apparatus receives and stores the service setting value and the service attribution information from the first upper device and the second upper device, thereby reflecting the service setting value and the service attribution information to an operation thereof.

10. The image forming system according to claim 9, wherein said second upper device further includes a screen portion for displaying the service setting value and the service attribution information transmitted from the image forming apparatus.

11. The image forming system according to claim 9, wherein said image forming apparatus further includes service capability information representing an acceptable range of the service setting value in the one of the service style, and said second upper device further includes a service style reference unit for determining whether the service setting value is within the acceptable range, said second upper device being arranged to retrieve the acceptable range from the service capability information when the service attribution information is input so that the service attribution information is input one more time when the service style reference unit determines that the service setting value is not within the acceptable range.

12. The image forming system according to claim 9, wherein said first upper device further includes a hash generation unit for calculating a first hash value of the service setting value and/or the service attribution information so that the service attribution information input unit outputs the first hash value to the service configuration file, and said second upper device further includes a hash checking unit for calculating a second hash value from the service setting value and/or the service attribution information so that the service configuration input unit identifies the first hash value from the service configuration file, said hash checking unit being arranged to compares the second hash value with the first hash value when the service configuration file is input, said second upper device being arranged to transmit the service setting value and/or the service attribution information to the image forming apparatus when the hash checking unit determines that the first hash value matches the second hash value, said second upper device being arranged to prompt the service configuration file to be input one more time when the hash checking unit determines that the first hash value does not match the second hash value.

13. The image forming system according to claim 9, wherein said first upper device further includes an encryption unit for encrypting the service setting value and/or the service attribution information so that the service attribution information input unit outputs the service setting value and/or the service attribution information thus encrypted to the service configuration file, and said second upper device further includes a decryption unit for decrypting the service setting value and/or the service attribution information so that the service configuration input unit identifies the service setting value and/or the service attribution information when the service configuration file is input.

14. The image forming system according to claim 9, wherein said image forming apparatus further includes a service information history unit for storing a history of the service setting value and/or the service attribution information, and said second upper device further includes a confirmation unit for displaying a confirmation screen and receiving an input of OK or NG, said confirmation unit being arranged to display the confirmation screen after the service configuration file is input and the second upper device identifies and transmits the service setting value and the service attribution information in the one of the service styles to the image forming apparatus, said second upper device being arranged to instruct the image forming apparatus to return to the service setting value and the service attribution information in a previous history when the confirmation unit receives the input of NG.

15. The image forming system according to claim 14, wherein said second upper device further includes a service configuration deleting unit for deleting the service configuration file, said confirmation unit being arranged to display the confirmation screen after the service configuration file is input and the second upper device identifies and transmits the service setting value and the service attribution information in the one of the service styles to the image forming apparatus, said service configuration deleting unit being arranged to delete the service configuration file when the confirmation unit receives the input of OK.

16. The image forming system according to claim 9, wherein said first upper device further includes a valid date setting unit for setting a valid date of the service setting value and/or the service attribution information, and said second upper device further includes a valid date checking unit for determining whether a current date is within the valid date and an identification unit for determining whether identification information of a user is valid so that the service configuration input unit inputs the service configuration file when the valid date checking unit determines that the current date is within the valid date and the identification unit determines that the identification information is valid.
